(19) United States
(12) Patent Application Publication
(10) Pub. No.: US 2010/0330381 A1
(43) Pub. Date: Dec. 30, 2010

(54) Method to add a radiant barrier to insulation and the product thereof

(76) Inventor: Donald Leo Peek, JR., Texarkana, TX (US)

Correspondence Address: Roger L. Maxwell PC, 5307 E. Mockingbird Lane, Fifth Floor, Dallas, TX, 75206, US

(21) Appl. No.: 12/459,305

(22) Filed: Jun. 30, 2009

(51) Int. Cl. B32B 15/04; E04B 1/62

(52) U.S. Cl. 428/457; 52/742.13

(57) ABSTRACT

A method to add a radiant barrier to existing thermal insulation includes collecting processed pieces of material, and pneumatically metering the processed pieces of material to add a radiant barrier to the existing thermal insulation.

### I. FIELD

The present disclosure is generally related to methods to add a radiant barrier to insulation and the products thereof.

### II. DESCRIPTION OF RELATED ART

Radiant barriers are commonly installed in residential, commercial, and industrial buildings to reduce summer heat gain and winter heat loss, and hence to reduce building cooling and heating energy usage.

Radiant barriers can reduce heat transfer by thermal radiation across the air space between the roof deck and the attic floor, where conventional insulation is often placed. All materials give off, or emit, energy by thermal radiation as a result of their temperature. The amount of energy emitted depends on the surface temperature and a property called the “emissivity.” The emissivity is a number between zero (0) and one (1). The higher the emissivity, the greater the emitted radiation.

A closely related material property is the “reflectivity.” Reflectivity is a measure of how much radiant heat is reflected by a material. The reflectivity is also a number between 0 and 1. For a material that does not allow radiation to pass directly though it, when the emissivity and reflectivity are added together, the sum is one (1). Hence, a material with a high reflectivity has a low emissivity, and vice versa. Radiant barrier materials generally have a high reflectivity (usually 0.9 or more) and a low emissivity (usually 0.1 or less) and face an open air space to perform properly.

On a sunny day, solar energy is absorbed by the roof, heating the roof sheathing and causing the underside of the sheathing and the roof framing to radiate heat downward toward the attic floor. When a radiant barrier is placed on the attic floor, much of the heat radiated from the hot roof is reflected back toward the roof. This makes the top surface of the insulation cooler than it would have been without a radiant barrier, and heat flow through the insulation is reduced. On a winter day, when a radiant barrier is installed on the attic floor, it emits little heat, keeping the insulation warmer than it would have been without a radiant barrier, and, again, heat flow through the insulation is reduced.

Heretofore, some radiant barriers have been formed with reinforced aluminum sheets. It takes extensive time and labor to install such sheets properly. Also, some radiant barriers are formed of heavy gauge material or of material that is reinforced in the manufacturing process to hold individually manually attached fasteners and to avoid tearing. Many times, the materials used to reinforce the aluminum sheet are combustible. The prior process of manually installing single layers of sheet materials often allows for degradation of its reflective properties over time due to dust settling on the flat surface and dulling its reflectivity. It also must be removed to even enter the attic space or to conduct repairs of any of the various mechanical and electrical systems typically contained in attic spaces and must be properly reattached after any exit.

Hence, prior art radiant barriers have the shortcomings and deficiencies of high cost, difficult installation requirements, combustibility, subject to degradation caused by dust, and difficulty doing repairs when it is installed.

### III. SUMMARY

In a particular embodiment, a method to add a radiant barrier to existing thermal insulation includes collecting processed pieces of material, and pneumatically metering the processed pieces of material to add a radiant barrier to the existing thermal insulation.

In another particular embodiment, a method to add a radiant barrier to insulation having a top surface includes collecting a material that reflects more than the insulation, and applying the material to the top of the insulation with blown air.

In another particular embodiment, a method to add a radiant barrier to an insulation system includes collecting radiant barrier material, and applying the radiant barrier material to the insulation system pneumatically.

In another particular embodiment, a method to add a radiant barrier to an insulation system having a top surface includes collecting radiant barrier material, and applying the radiant barrier material to the top of the insulation system pneumatically.

In another particular embodiment, an insulation system includes a layer of insulation having a top surface, and a layer of pieces of material laying on the top surface.

In another particular embodiment a radiant barrier including pieces of aluminum foil that are deposited on insulation material with blown air.

One particular advantage provided by embodiments of the method to add a radiant barrier to insulation is that extensive time and labor to install it is not required. A particular advantage provided by embodiments of the product of the method to add a radiant barrier to insulation is that it is not combustible. Another particular advantage provided by embodiments of the product of the method to add a radiant barrier to insulation is that its reflective properties do not degrade over time due to dust settling on the flat surface and dulling its reflectivity. Another particular advantage provided by embodiments of the product of the method to add a radiant barrier to insulation is that one does not need to remove it to enter the attic space or to conduct repairs of any of the various mechanical and electrical systems typically contained in attic spaces, nor does one need to reattach it upon exit.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1a is a block diagram of a particular illustrative embodiment of a product of a method to apply a radiant barrier to existing thermal insulation that shows its reflectivity ability;

FIG. 1b is a block diagram of a particular illustrative embodiment of a product of a method to apply a radiant barrier to existing thermal insulation that shows its emissivity ability.

FIG. 2 is an operational view of a method to add a radiant barrier to existing insulation;

FIG. 3 is a flow chart of a particular illustrative embodiment of a method to add a radiant barrier to insulation;

FIG. 4 is a flow chart of a particular illustrative embodiment of a method to add a radiant barrier to insulation;

FIG. 5 is a flow chart of a particular illustrative embodiment of a method to add a radiant barrier to insulation;

FIG. 6 is a flow chart of a particular illustrative embodiment of a method to add a radiant barrier to insulation;

FIG. 7 is a block diagram of a particular illustrative embodiment of a product of a method to add a radiant barrier to insulation; and

FIG. 8 is a block diagram of a particular illustrative embodiment of a product of a method to add a radiant barrier to insulation.

### V. DETAILED DESCRIPTION

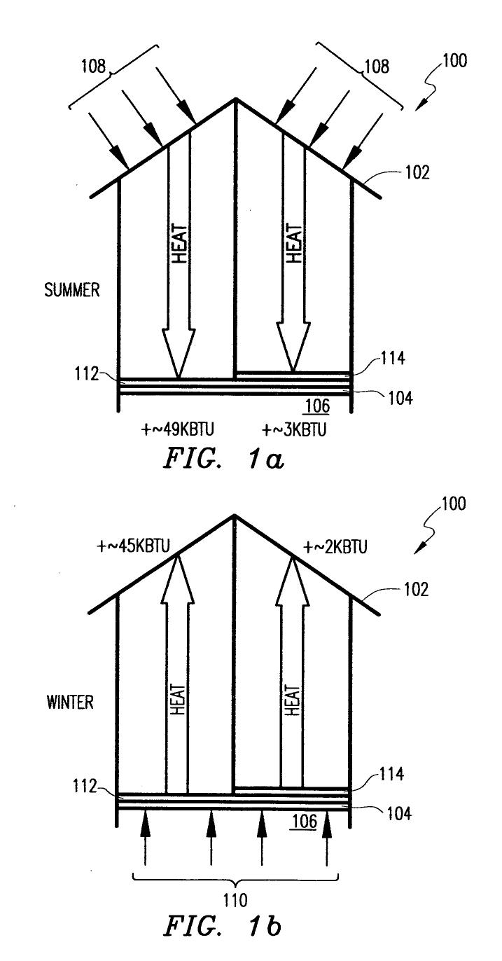

Referring to FIGS. 1a and 1b, block diagrams of a particular illustrative embodiment of the area in which a product of a method to apply a radiant barrier to existing thermal insulation can be found is disclosed and generally designated 100. Area 100 is the attic of a house or building with an attic roof 102 and an attic floor 104. Beneath the attic floor 104 is the living/working area 106 of the building or house. FIG 1a illustrates a situation in which it is designed to keep area 106 cool—a typical summer situation, as labeled in the figure. FIG. 1b illustrates a situation in which it is desired to keep area 106 warm—a typical winter situation, as labeled in the figure. In FIG. 1a—the typical summer situation—rays from the sun 108 are shown striking attic roof 102. The rays from the sun 108 cause heat (shown by labeled arrows) to be transferred from the attic roof 102 towards the attic floor 104. In FIG. 1b, rays of heat 110 from area 106 are shown striking attic floor 104. The rays of heat 110 cause heat (shown by labeled arrows) to be transferred from the attic floor 104 towards the attic roof 102.

In both FIGS. 1a and 1b on the attic floor is existing insulation 112. On the left halves of FIGS. 1a and 1b, there is nothing on the top surface of the existing insulation 112 (that is, on the surface of the insulation 112 facing the open space between the attic floor 104 and the attic roof 102). On the right halves of FIGS. 1a and 1b, a radiant barrier 114 is shown laying on the top surface of the insulation 112.

FIG. 1a shows that heat from the rays from the sun 108 cause a transfer of approximately 49K British thermal units or BTUs (a term commonly used to indicate heat value) to the attic floor 104 when no radiant barrier 114 is present and transfer of only about 3 BTUs when a radiant barrier 114 is present (actual values depend on a number of measurements, such as the temperature of the attic floor 104, the temperature of the attic roof 102, etc.). This is because the radiant barrier 114 reflects a significant amount of heat that strikes the top surface of the existing insulation 112. This means that the existing insulation 112 will have less heat to deal with, and that the living or working area 106 is cooler if a radiant barrier 114 is present.

FIG. 1b shows that heat from rays 110 cause a transfer of approximately 45K BTUs to the attic roof 102 when no radiant barrier 114 is present and transfer of only about 2K BTUs when a radiant barrier 114 is present. This is because the radiant barrier 114 emits very little heat from its top surface. This means that more heat is retained in area 106, which is desired in a winter situation.

Together, FIGS. 1a and 1b show that a radiant barrier 114 can effectively keep a living or working area 106 cooler in the summer by keeping heat out and warmer in the winter by keeping heat in, which can lead to significant reduction in energy usage, and, therefore, significant cost savings.

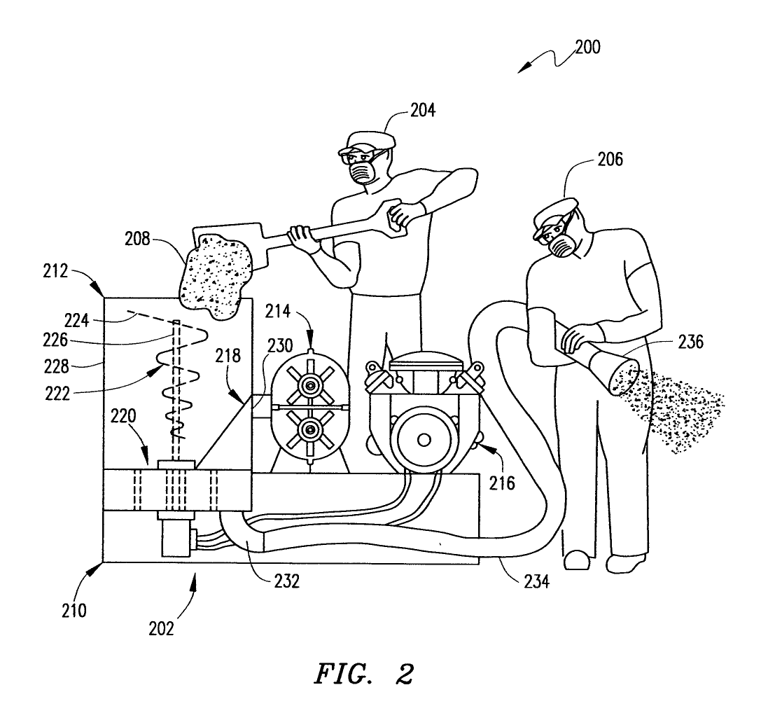

Referring to FIG. 2, a method to add a radiant barrier to existing insulation is shown and generally designated 200. Method 200 involves a portable pneumatic blower 202 that can be operated by two workers 204 and 206.

Worker 204 places material 208 in the pneumatic blower 202. Material 208 can be processed material. Material 208 can be processed pieces of material comprising low emissivity (low-e) material. Material 208 can be processed pieces of material comprising bits of aluminum foil. Material 208 can be a material that reflects more than conventional insulation. Material 208 can be material that reflects more and emits less than conventional insulation. Material 208 can comprise foil material. Material 208 can comprise aluminum foil. Material 208 can comprise loose bits and pieces of aluminum foil.

Pneumatic blower 202 includes a base 210. Base 210 supports a hopper 212, a blower 214 and an engine 216.

Hopper 212 includes an airlock 218, a feeder 220 and an auger 222. Auger 222 includes a spiral blade 224 and auger shaft 226 housed in a shell 228. Blade 224 is configured to drive material 208 towards feeder 220 when the shaft 226 is driven in a predetermined direction by engine 216.

The shell 228 defines an opening 230 that enables air from blower 214 to enter hopper 212. Airlock or air chamber 218 separates the material 208 from the air entering through opening 230 and channels the air downwardly towards feeder 220.

Material 208 is gravity fed into feeder 220. The feeder 220 conveys the material 208 underneath the air chamber 218, wherein the pressurized air in the chamber 218 forces the material 208 in the feeder 220 to exit therefrom via an outlet 232 into a flexible hose 234. The person 206 holds a distal end 236 of the hose 234 to control the placement of material that flows from the hose 234 while the blower 214 runs. The material that flows from the distal end 236 of the hose 234 is pneumatically metered material 208—e.g., air blown loose bits and pieces of a low-e material such as aluminum foil.

Alternatives are possible. For example, the pneumatic blower 202 can be assembled in different configurations and/or with various different components as described in U.S. Pat. No. 7,125,204, the contents of which are incorporated herein by this reference thereto. The pneumatic blower 202 can be any size, such as truck mounted or portable and/or handheld. Ideally, the pneumatic blower is relatively small so as to be easily positioned in a conventional attic where it can be used to pneumatically meter material 208. A single worker can both load material 208 into the blower 202 and operate the blower 202. The material can be in any form for convenient handling, such as in a bag containing loose bits and pieces of aluminum foil fed directly into a blower. Method 200 is an illustrative method to pneumatically deposit radiant barrier material on the top surface of existing insulation in an attic.

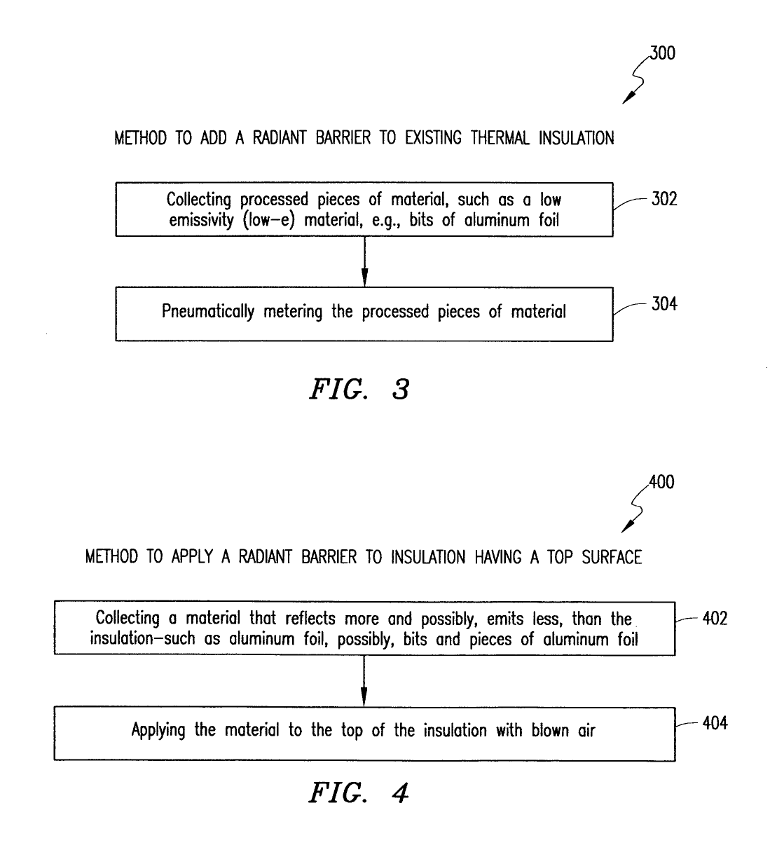

Referring to FIG. 3, a flow chart of a method to add a radiant barrier to existing thermal insulation is shown and generally designated 300. At step 302, one collects processed pieces of material, such as a low emissivity (low-e) material (e.g., bits of aluminum foil). At step 302, one pneumatically meters the processed pieces of material.

Referring to FIG. 4, a flow chart of a method to add a radiant barrier to insulation having a top surface is shown and generally designated 400. At step 402, one collects a material that reflects more and possibly, emits less, than the insulation. This material could be aluminum foil, and possibly, loose bits and pieces of aluminum foil. At step 404, one applies the material to the top of the insulation with blown air.

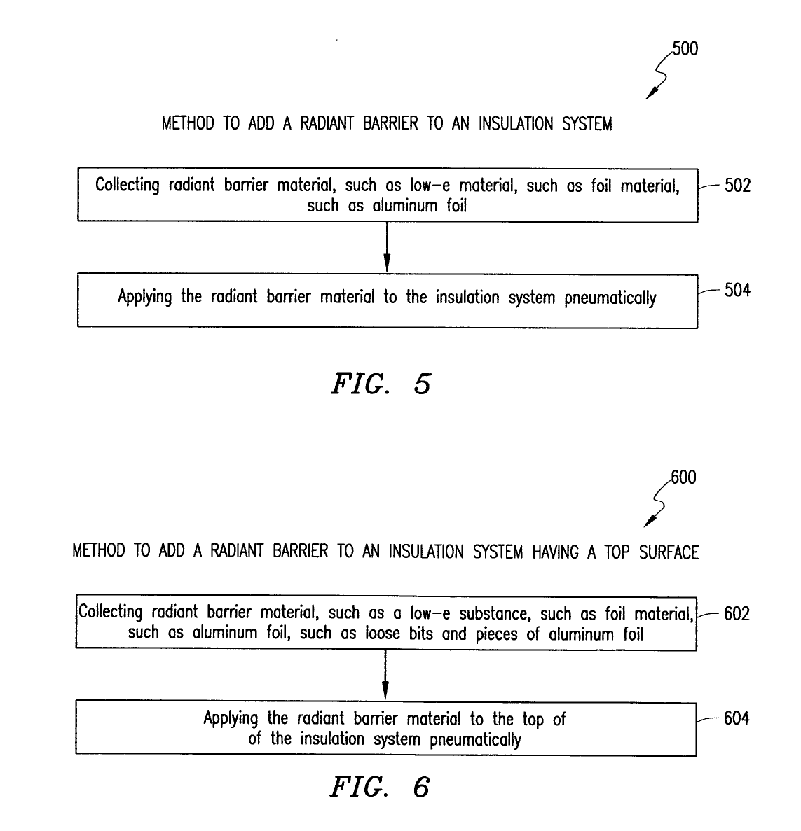

Referring to FIG. 5, a flow chart of a method to add a radiant barrier to an insulation system is shown and generally designated 500. At step 502, one collects radiant barrier material, such as low-e material, such as foil material, such as aluminum foil. At step 504, one applies the radiant barrier material to the insulation system pneumatically.

Referring to FIG. 6, a flow chart of a method to add a radiant barrier to an insulation system having a top surface is shown and generally designated 600. At step 602, one collects radiant barrier material, such as low-e substance, such as foil material, such as aluminum foil, such as loose bits and pieces of aluminum foil. At step 604, one applies the radiant barrier material to the top of the insulation system pneumatically.

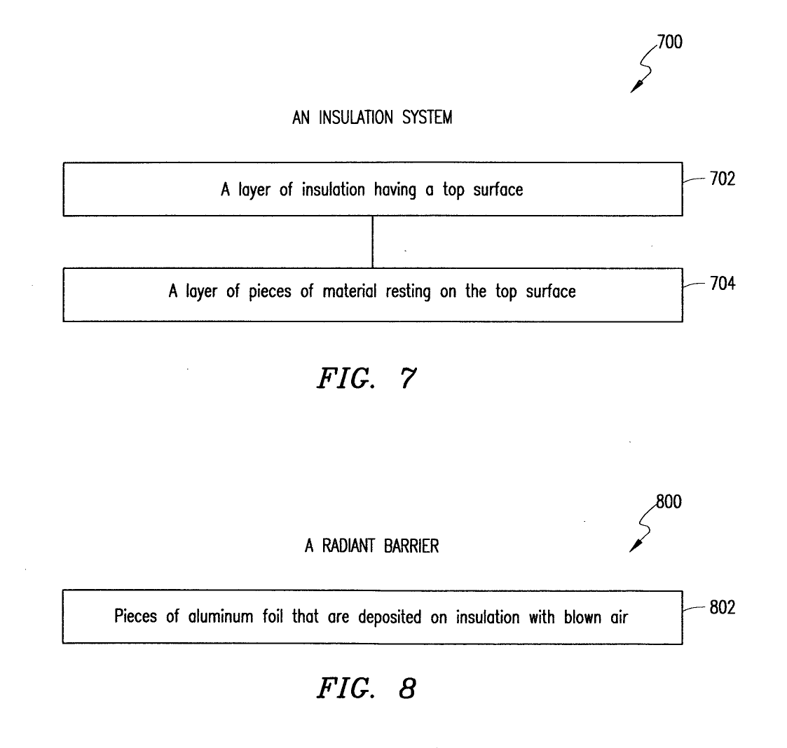

Referring to FIG. 7, a block diagram of a particular illustrative embodiment of an insulation system is depicted and designated system 700. System 700 is formed by elements 702 and 704. Element 702 is a layer of insulation having a top surface. Element 704 is a layer of pieces of material resting on the top surface—that is, material spread by the method of the present invention.

Referring to FIG. 8, a block diagram of a particular illustrative embodiment of a radiant barrier is depicted and designated system 800. Radiant barrier 700 is formed of pieces of aluminum foil that are deposited on insulation with blown air 702.

The method of the present invention and products thereof offer a number of advantages over the prior art. One particular advantage provided by embodiments of the method to add a radiant barrier to existing insulation is that extensive time and labor is not required for installation. A particular advantage provided by embodiments of the product of the present invention is that it is not combustible—that is, no element contained within the metered material is combustible. Another particular advantage provided by embodiments of the product of the present invention is that its reflective properties do not degrade over time due to dust settling on the flat surface and dulling its reflectivity. Because the metered material settles in on angles, any dust on its surface does not effectively reduce its reflectivity. Another particular advantage provided by embodiments of the product of the present invention is that one does not need to remove it to enter the attic space or to conduct repairs of any of the various mechanical and electrical systems typically contained in attic spaces, nor does one need to reattach it upon exit.

Those of skill will appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method to add a radiant barrier to existing thermal insulation, comprising:
collecting processed pieces of material; and
pneumatically metering the processed pieces of material to add a radiant barrier to the existing thermal insulation.

2. The method of claim 1, wherein the processed pieces of material comprise low emissivity (low-e) material.

3. The method of claim 2, wherein the processed pieces of material comprise bits of aluminum foil.

4. The product of the method of claim 1.

5. A method to apply a radiant barrier to insulation having a top surface, comprising:
collecting a material that reflects more than the insulation; and
applying the material to the top of the insulation with blown air.

6. The method of claim 5, wherein the material that reflects more than the insulation also emits less than the insulation.

7. The method of claim 6, wherein the material that emits less and reflects more than the insulation comprises aluminum foil.

8. The method of claim 7, wherein the aluminum foil comprises looses bits and pieces of aluminum foil.

9. A product formed by the method of claim 5.

10. A method to add a radiant barrier to an insulation system, comprising:
collecting radiant barrier material; and
applying the radiant barrier material to the insulation system pneumatically.

11. The method of claim 10, wherein the radiant barrier material comprises low emissivity (low-e) material.

12. The method of claim 11, wherein the low-e material comprises foil material.

13. The method of claim 12, wherein the foil material comprises aluminum foil.

14. A product of the method of claim 10.

15. A method to add a radiant barrier to an insulation system having a top surface, comprising:
collecting radiant barrier material; and
applying the radiant barrier material to the top of the insulation system pneumatically.

16. The method of claim 15, wherein the radiant barrier material comprises a low emissivity (low-e) substance.

17. The method of claim 15, wherein the low-e substance comprises a foil material.

18. The method of claim 17, wherein the foil material comprises aluminum foil.

19. The method of claim 18, wherein the aluminum foil comprises loose bits and pieces of aluminum foil.

20. A product formed by the method of claim 15.

21. An insulation system, comprising:
a layer of insulation having a top surface; and
a layer of pieces of material laying on the top surface.

22. A radiant barrier, comprising:
pieces of aluminum foil that are deposited on insulation material with blown air.
